(19) United States
(12) Patent Application Publication
(10) Pub. No.: US 2018/0082354 A1
(43) Pub. Date: Mar. 22, 2018

(54) METHODS AND APPARATUS FOR ANALYZING TRANSACTION DATA RELATING TO ELECTRONIC COMMERCE

(71) Applicant: MASTERCARD INTERNATIONAL INCORPORATED, Purchase, NY (US)

(72) Inventor: Rakesh Tiwari, Delhi (IN)

(21) Appl. No.: 15/707,671

(22) Filed: Sep. 18, 2017

(30) Foreign Application Priority Data
Sep. 19, 2016 (SG) 10201607812R

(51) Int. Cl. G06Q 30/06; G06Q 20/24; G06Q 20/26; G06Q 20/14

(52) U.S. Cl. CPC G06Q 30/0635; G06Q 20/24; G06Q 20/14; G06Q 30/0641; G06Q 20/26

(57) ABSTRACT

A computer implemented method of analyzing transaction data relating to electronic commerce is provided which comprises: receiving, in an electronic commerce analysis server, first transaction data indicating transactions made by payment cards of a first payment card type; identifying, in the electronic commerce analysis server, first electronic commerce transactions in the first transaction data; calculating, in the electronic commerce analysis server, an electronic commerce metric for the first payment card type using the first electronic commerce transactions; receiving, in the electronic commerce analysis server, first electronic billing information for the payment cards of the first payment card type; calculating, in the electronic commerce analysis server, an electronic billing metric for the first payment card type using the first electronic billing information; and determining, in the electronic commerce analysis server, a composite metric for the first payment card type from the calculated electronic commerce and electronic billing metrics.

### TECHNICAL FIELD AND BACKGROUND

The present disclosure relates to a method and system for processing data. In particular, it provides methods and apparatus for analyzing transactions relating to electronic commerce.

Electronic commerce (often referred to as ‘e-commerce’) has experience rapid growth in the past years. Many online retailers sell products at a significantly lower price than conventional retailers. For example electronics products are often sold with an online price of up to 40% lower compared to high street shops. This has led to a change in consumer behavior. Consumers are increasing looking to online merchants to purchase high cost items such as electronics products. Many issuers of payment card products such as credit cards wish to capture this growing market.

Recently there has also been growth in electronic billing for payment card products. When a customer has signed up for electronic billing, statements for the payment card product are issued electronically rather than sent by mail. This can offer a significant cost saving for the issuer and there is an additional environmental saving as fewer resources are used.

While issuers of payment cards wish to increase electronic commerce and electronic billing on their payment card products, if is often difficult to identify the existing situation as the rate of change may be fast.

### SUMMARY

In general terms, the present disclosure proposes methods and apparatus for analyzing electronic commerce transactions. The analysis may be carried out for a particular payment card type, for example a particular credit card product such as a ‘gold’ or ‘platinum’ credit card issued by an issuer. The analysis takes into account an electronic commerce metric and an electronic billing metric. The electronic commerce metric may be calculated from the proportion of transactions that are electronic commerce transactions made using payment cards of the payment card type being analyzed. The electronic billing metric may be calculated from the proportion of payment card customers that use electronic billing rather than conventional paper billing.

According to a first aspect of the present invention, there is provided a computer implemented method for analyzing transaction data relating to electronic commerce. The method comprises: receiving, in an electronic commerce analysis server, first transaction data indicating transactions made by payment cards of a first payment card type; identifying, in an electronic commerce transaction identification module of the electronic commerce analysis server, first electronic commerce transactions in the first transaction data; calculating, in an electronic commerce metric calculation module of the electronic commerce analysis server, an electronic commerce metric for the first payment card type using the first electronic commerce transactions; receiving, in the electronic commerce analysis server, first electronic billing information for the payment cards of the first payment card type; calculating, in an electronic billing metric calculation module of the electronic commerce analysis server, an electronic billing metric for the first payment card type using the first electronic billing information; and determining, in a composite metric calculation module of the electronic commerce analysis server, a composite metric for the first payment card type from the electronic commerce metric for the first payment card type and the electronic billing metric for the first payment card type.

In an embodiment, the method further comprises analyzing the composite metric for the first payment card type in an analysis module of the electronic commerce analysis server.

In an embodiment, analyzing the composite metric for the first payment card type comprises comparing the composite metric for the first payment card type with composite metric value. The composite metric value maybe an average composite metric for a plurality of payment card types or a maximum composite metric value for a plurality of payment card types.

In an embodiment, analyzing the composite metric value comprises estimating a decrease in cost and/or an increase in revenue for the first payment card type if the composite metric for the first payment card type increased to the composite metric value.

In an embodiment, calculating the electronic commerce metric for the first payment card type using the first electronic commerce transactions comprises calculating a proportion of the transactions made by the first payment card type that are electronic commerce transactions.

In an embodiment, calculating the electronic billing metric for the first payment card type using the first electronic billing information comprises calculating a proportion of first payment card accounts registered for electronic billing.

In an embodiment, wherein determining the composite metric for the first payment card type from the electronic commerce metric for the first payment card type and the electronic billing metric for the first payment card type comprises calculating a weighted sum of the electronic commerce metric for the first payment card type and the electronic billing metric for the first payment card type.

In an embodiment the method further comprises: receiving, in the electronic commerce analysis server, second transaction data indicating transactions made by payment cards of a second payment card type; identifying second electronic commerce transactions in the second transaction data; calculating an electronic commerce metric for the second payment card type using the second electronic commerce transactions; receiving second electronic billing information for the payment cards of the second payment card type; calculating an electronic billing metric for the second payment card type from the electronic commerce metric for the second payment card type and the electronic billing metric for the second payment card type; and determining a composite metric for the second payment card type from the electronic commerce metric for the second payment card type and the electronic billing metric for the second payment card type.

The method may further comprise analyzing the composite metric for the first payment card type and the composite metric for the second payment card type. Analyzing the composite metric for the first payment card type and the composite metric for the second payment card type may comprise comparing the composite metric for the first payment card type and the composite metric for the second payment card type.

According to a second aspect, there is provided an apparatus for analyzing transaction data relating to electronic commerce. The apparatus comprises: a computer processor and a data storage device, the data storage device having an electronic commerce transaction identification module; an electronic commerce metric calculation module; an electronic billing metric calculation module; and a composite metric calculation module comprising non-transitory instructions operative by the processor to: receive first transaction data indicating transactions made by payment cards of a first payment card type; identify first electronic commerce transactions in the first transaction data; calculate an electronic commerce metric for the first payment card type using the first electronic commerce transactions; receive first electronic billing information for the payment cards of the first payment card type; calculate an electronic billing metric for the first payment card type using the first electronic billing information; and determine a composite metric for the first payment card type from the electronic commerce metric for the first payment card type and the electronic billing metric for the first payment card type.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram of a data processing system according to an embodiment of the present invention;

FIG. 2 is a block diagram illustrating a payment network incorporating an electronic commerce analysis server according to an embodiment of the present invention;

FIG. 3 is a block diagram illustrating a technical architecture of the apparatus according to an embodiment of the present invention;

FIG. 4 is a flowchart illustrating a method of analyzing transaction data relating to electronic commerce according to an embodiment of the present invention;

FIG. 5 is a table showing the calculation of composite metric for four payment card types according to an embodiment of the present invention; and

FIG. 6 shows an example of the analysis of the composite metric in an embodiment of the present invention.

### DETAILED DESCRIPTION

As used herein, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

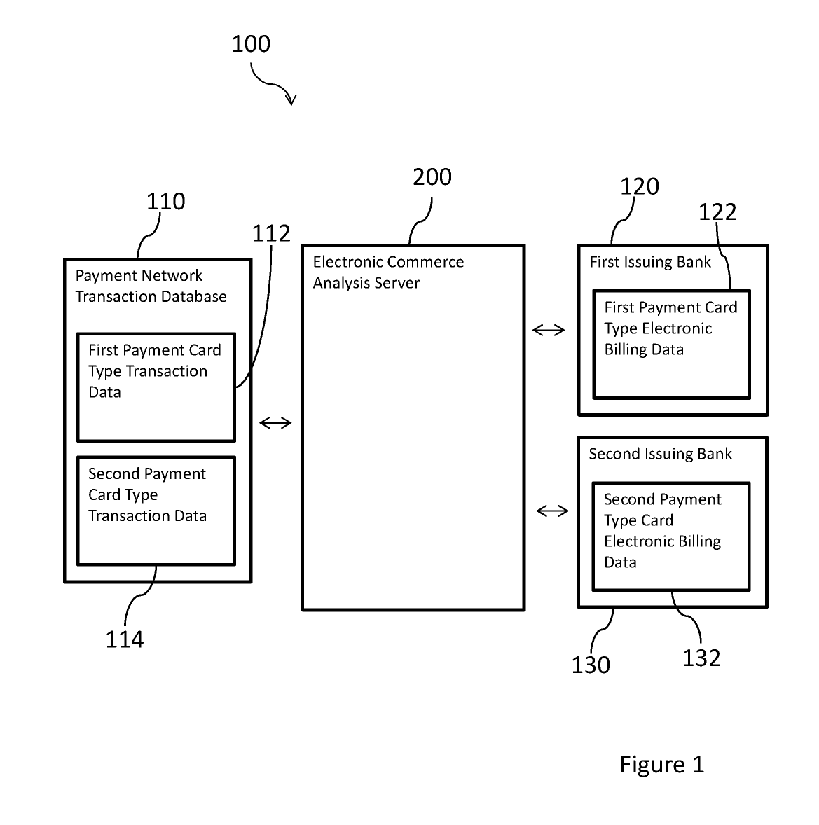

FIG. 1 is a block diagram showing a data processing system according to an embodiment of the present invention. The data processing system 100 comprises an electronic commerce analysis server 200. The electronic commerce analysis server 200 is coupled to a payment network transaction database 110, a first issuing bank server 120 and a second issuing bank server 130.

The first issuing bank server 120 is a server associated with a first issuing bank organization which issues payment cards of a first payment card type. The first issuing bank server 120 stores first payment card type electronic billing information 122. The first payment card type electronic billing information indicates which payment cards of the first payment card type are set up to use electronic billing.

The second issuing bank server 130 is a server associated with a second issuing bank organization which issues payment cards of a second payment card type. The second issuing bank server 130 stores second payment card type electronic billing information 132. The second payment card type electronic billing information 132 indicates which payment cards of the second payment card type are set up to use electronic billing.

The data stored in the payment network transaction database 110; the first payment card type electronic billing information 122; and the second payment card type electronic billing information 132 may be resident on different servers or server clusters. The servers may be either within a single data warehouse or distributed over a plurality of data warehouses. The data processed by the electronic commerce analysis server 200 may be retrieved from the servers, and cleaned and stored in a data warehouse prior to the analyses being conducted. Alternatively, the electronic commerce analysis server 200 may receive the data from servers which may be operated by the different providers.

The payment network data transactions database 110 stores first payment card type transaction data 112 and second payment card type transaction data 114. The first payment card type transaction data 112 comprises data on transactions carried out using a first payment card type. In this description the term payment card type is used to refer to a payment card product such as a gold credit card of issuing bank. As the payment network processes all types of transactions such as POS, e-commerce etc; the payment network data transactions database 110 stores all transactions by transaction type and by issuer-product combination.

The second payment card type transaction data 114 comprises data on transactions carried out using a second payment card type. It is envisaged that in embodiments of the present invention more than two payment card types may be analysed, however for the sake of simplicity two are shown in FIG. 1. Each of the first payment card type transaction data 112 and the second payment card type transaction data 114 comprise indications of transactions, which indicates information including the time and date of transactions; transaction amount; the card number of a payment card used for the transaction; and the merchant at which the transaction was carried out. The first payment card type transaction data 112 and the second payment card type transaction data may also comprise point of interest (POI) flags which indicate whether a transaction is an electronic commerce transaction. When a merchant gets associated with a payment network through an acquirer, the merchant is allocated a POI classification which identifies whether the merchant is a bricks & mortar merchant or an electronic commerce merchant.

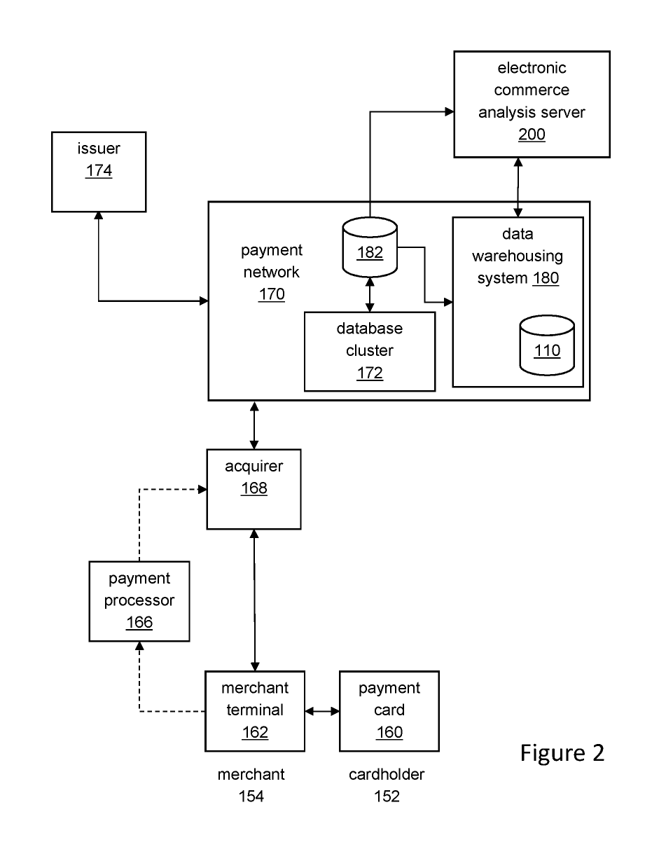

FIG. 2 shows an example of data processing system which generates the transaction data of the payment network transactions database 110. As shown in FIG. 2, the electronic commerce analysis server 200 receives transaction data from a payment network 170, such as the payment network operated by MasterCard.

The payment network 170 acts as an intermediary during a transaction being made by a cardholder 152 using a payment card 160 at a merchant terminal 162 of a merchant 154. In particular, the cardholder 152 may present the payment card 160 to merchant terminal 162 of merchant 164 as payment for goods or services. The merchant terminal 162 may be a point of sale (POS) device such as a magnetic strip reader, chip reader or contactless payment terminal, or a website having online e-commerce capabilities, for example. A merchant 154 may operate one or a plurality of merchant terminals 162. The merchant terminal 162 communicates with an acquirer computer system 168 of a bank or other institution with which the merchant 154 has an established account, in order to request authorisation for the amount of the transaction (sometimes referred to as ticket size) from the acquirer system 168. In some embodiments, if the merchant 154 does not have an account with the acquirer 168, the merchant terminal 162 can be configured to communicate with a third-party payment processor 166 which is authorised by acquirer 168 to perform transaction processing on its behalf, and which does have an account with the acquirer entity.

The acquirer system 168 routes the transaction authorisation request from the merchant terminal 162 to computer systems of the payment network 170. The transaction authorisation request is then routed by payment network 170 to computer systems of the appropriate issuer institution (e.g., issuer 174) based on information contained in the transaction authorisation request. The issuer institution 174 is authorised by payment network 170 to issue payment devices 160 on behalf of customers 152 to perform transactions over the payment network 170. Issuer 174 also provides funding of the transaction to the payment network 170 for transactions that are approved.

The computer systems of the issuer 174 analyse the authorisation request to determine the account number submitted by the payment card 160, and based on the account number, determine whether the account is in good standing and whether the transaction amount is covered by the cardholder's account balance or available credit. Based on this, the transaction can be approved or declined, and an authorisation response message transmitted from issuer 174 to the payment network 170, which then routes the authorisation response message to the acquirer system 178. The acquirer system 178, in turn, sends the authorisation response message to merchant terminal 162. If the authorisation response message indicates that the transaction is approved, then the account of the merchant 154 (or of the payment processor 166 if appropriate) is credited by the amount of the transaction following subsequent clearing and settlement processes, and the cardholder's account is debited accordingly.

During each authorisation request as described in the previous paragraphs, the payment network 170 stores transaction information in a payment network transaction database 110 accessible via a database cluster 172. The database cluster 172 may comprise one or more physical servers. In some embodiments, the payment network transaction database 110 may be distributed over multiple devices which are in communication with one another over a communications network such as a local-area or wide-area network. In some embodiments, the payment network transaction database 110 may be in communication with a data warehousing system 180 comprising a data warehouse database 182 which may store copies of the transaction data, and/or cleaned and/or aggregated data which are transformed versions of the transaction data.

The data warehouse database 182 may also comprise records relating to individual cardholders, which, for example, may associate demographic information such as age, gender, number of dependents and salary range with a card identifier (e.g., a PAN), thereby permitting transaction data to be matched to demographic data. In some embodiments, each transaction record stored in the data warehouse database 182 may already have the matched demographic data stored as part thereof.

Transaction records (or aggregated data derived therefrom) may be directly accessible for the purposes of performing analyses, for example by the electronic commerce analysis server 200, from transactions database 160. Alternatively, or in addition, the transaction records (or aggregated data derived therefrom) may be accessed (for example, by the electronic commerce analysis server 200) from the data warehouse database 182. Accessing the transaction records from the data warehouse database 182, instead of the transactions database 236, has the advantage that the load on the payment network transaction database 110 is reduced.

The transaction records may comprise a plurality of fields, including acquirer identifier/card accepter identifier (the combination of which uniquely defines the merchant); merchant category code (also known as card acceptor business code), that is, an indication of the type of business the merchant is involved in (for example, a gas station); cardholder base currency (i.e., U.S. Dollars, Euros, Yen, etc.); the transaction environment or method being used to conduct the transaction; card identifier (e.g., card number); time and date; location (full address and/or GPS data); transaction amount (also referred to herein as ticket size); terminal identifier (e.g., merchant terminal identifier or ATM identifier); and response code (also referred to herein as authorization code). Other fields may be present in each transaction record.

Each terminal identifier may be associated with a merchant 154, for example in a merchant database of the payment network 170. Typically, a particular merchant 154 will have a plurality of merchant terminal identifiers, corresponding to merchant terminals 162, associated with it. The merchant may have an associated point of interest (POI) classification which identifies whether the merchant is an electronic commerce merchant or a bricks & mortar merchant.

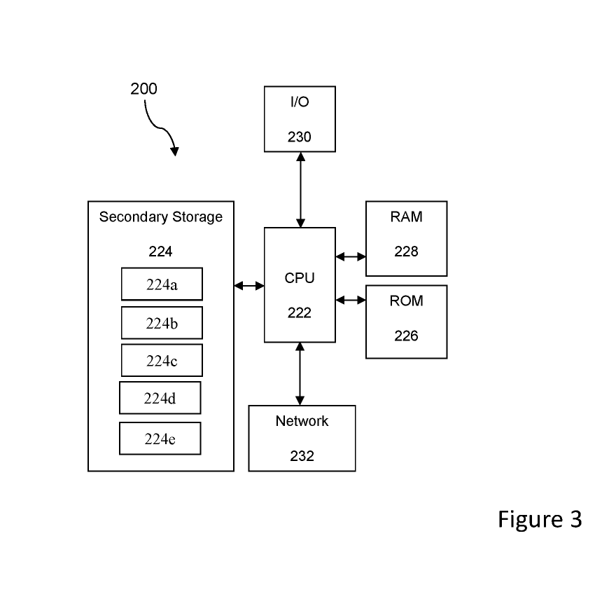

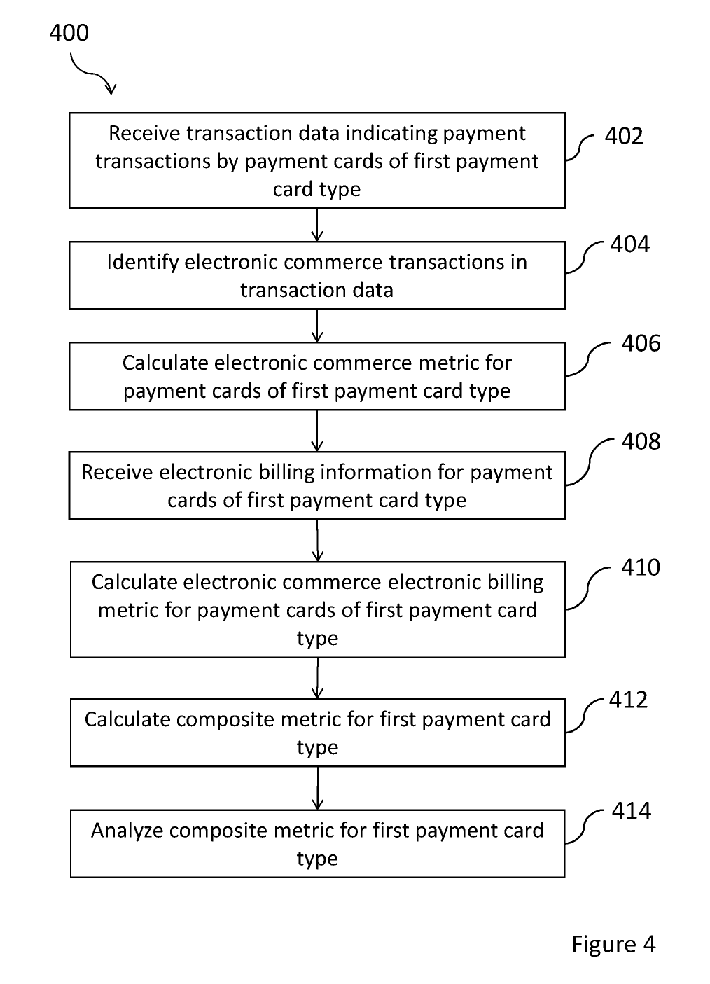

FIG. 3 is a block diagram showing a technical architecture of the server of the electronic commerce analysis server 200 for performing an exemplary method 400 which is described below with reference to FIG. 4. Typically, the method 400 is implemented by a computer having a data-processing unit. The block diagram as shown FIG. 3 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has an electronic commerce transaction identification module 224a, an electronic commerce metric calculation module 224b, an electronic billing metric calculation module 224c, a composite metric calculation module 224d and an analysis module 224e comprising non-transitory instructions operative by the processor 222 to perform various operations of the method of the present disclosure. As depicted in FIG. 3, the modules 224a-224e are distinct modules which perform respective functions implemented by the electronic commerce analysis server 200. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a-224e is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the exemplary method 400 will now be described with reference to FIG. 4 in respect of analysis of transaction data relating to electronic commerce. It should be noted that enumeration of operations is for purposes of clarity and that the operations need not be performed in the order implied by the enumeration.

In step 402, the electronic commerce analysis server 200 receives the first payment card type transaction 112 data from the payment network transaction database 110. The first payment card type transaction data may relate to transactions over a specific time period, for example a 6 month period or a 3 month period (a quarter year time period).

In step 404, the electronic transaction identification module 224b of the electronic commerce analysis server 200 identifies electronic commerce transactions in the first payment card type transaction 112. The electronic transaction identification module 224b of the electronic commerce analysis server 200 may use the POI field for the transaction data to identify electronic commerce transactions.

In step 406, the electronic commerce metric calculation module 224b of the electronic commerce analysis server 200 calculates an electronic commerce metric for the first payment card type using the electronic commerce transactions identified in step 404. The electronic commerce metric may be calculated as the proportion of transactions made by using payment cards of the first payment card type that are electronic commerce transactions. Alternatively, the electronic commerce metric may be calculated as the proportion of the total spend on payment cards of the first payment card type that was made on electronic commerce transactions.

In step 408, the electronic commerce analysis server 200 receives first payment card type electronic billing data 122 from the first issuing bank server 120. The first payment card type electronic billing data 122 specifies which of payment card accounts for payment cards of the first payment card type are registered for electronic billing. The first payment card type electronic billing data may take the form of an identifier of each payment card account for payment cards of the first payment card account and an indication for each payment card account whether that payment card account is registered for electronic billing.

In step 410 the electronic billing metric calculation module 224c of the electronic commerce analysis server 200 calculates an electronic billing metric for the first payment card type. The electronic billing metric may be calculated as the proportion of payment card accounts for payment cards of the first payment card type which are registered for electronic billing. This proportion may be expressed as a percentage, or a fraction of the total number of payment cards of the first payment card type.

In step 412 the composite metric calculation module 224d of the electronic commerce analysis server 200 calculates a composite metric for the first payment card type using the electronic commerce metric for the first payment card type and the electronic billing metric for the first payment card type. The composite metric may be calculated as a weighted sum of the electronic commerce metric for the first payment card type and the electronic billing metric for the first payment card type.

In step 414 the analysis module 224e of the of the electronic commerce analysis server 200 analyses the composite metric calculated for the first payment card type.

In some embodiment, the analysis carried out in step 414 may involve comparing the composite metric for a first payment card with a composite metric value.

The composite metric value may be a composite metric for a second payment card type. The composite metric for the second payment card type may be calculated by the electronic commerce analysis server 200 carrying out steps 402 to 412 for the second payment card type.

In other embodiments, the composite metric value may be an average value or a maximum value for a plurality of different payment card types.

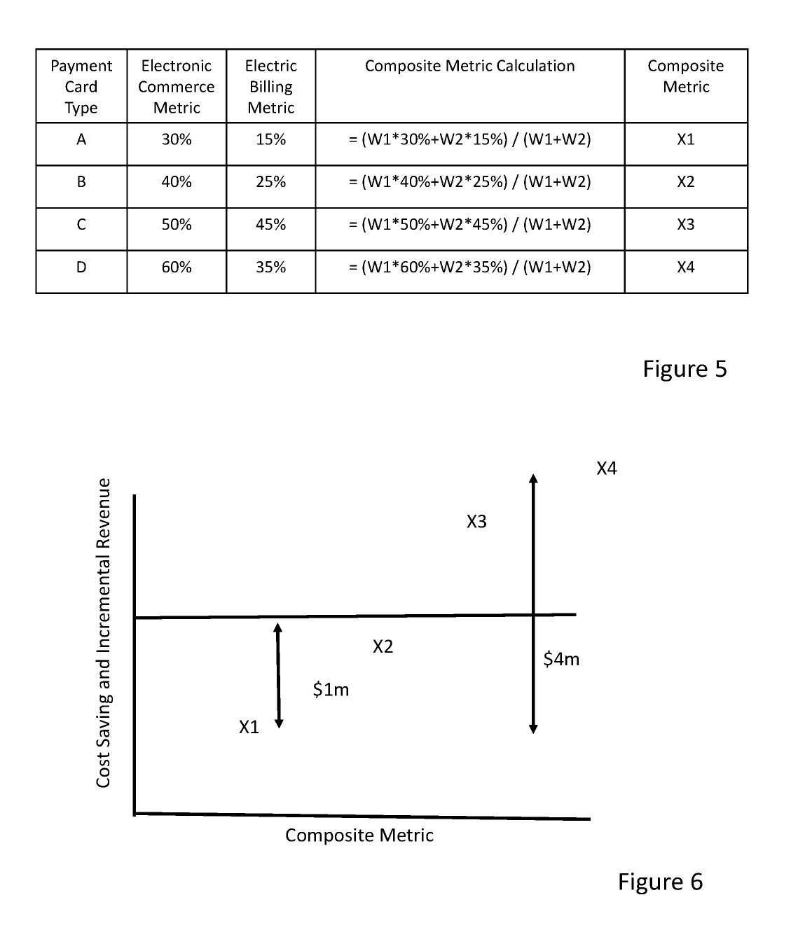

FIG. 5 is a table showing the calculation of composite metric for four payment card types. As shown in FIG. 5, composite metrics are determined for each of payment card types A to D. The composite metrics are calculated as a weighted sum of the electronic commerce metric and the electric billing metric for each payment card type. Thus, the final composite metrics for each payment card type is denoted as ×1 to ×4.

FIG. 6 shows an example of the analysis of the composite metric in an embodiment of the present invention. The analysis shown in FIG. 6 may be carried out by the analysis module 224e of the of the electronic commerce analysis server 200. The analysis shown in FIG. 6 corresponds to the composite metrics shown in FIG. 5.

As shown in FIG. 6, a revenue value is calculated for each of the four payment card types. FIG. 6 is a plot of cost saving and incremental revenue against composite metric for the different payment card types. When a customer moves from a mail bill to electronic billing, there will be a cost saving for the issuing bank as the cost associated with billing the customer will be lower. Similarly, when customers make more electronic commerce transactions there may be an increase in revenue from those customers.

As shown in FIG. 6, the composite score is approximately directly proportional cost saving and incremental revenue. Thus it is possible using the methods described above to estimate the potential increase in cost saving, an incremental revenue that may be possible for a payment card issuer by increasing the composite score for payment cards. As shown in FIG. 6, for a payment card type having a composite score of ×1, the potential cost saving an incremental revenue increase is $1 m if the composite score is increased to the average composite score for the payment cards under analysis. Similarly if the composite score of the payment card type was increase to the best in class composite score, which in this case is ×4, the increase in cost saving and incremental revenue would be $4 m. Thus embodiments of the present invention allow the provision of information that can be used by payment card issuers to identify possible cost savings and opportunities for increasing revenue.

Whilst the foregoing description has described exemplary embodiments, it will be understood by those skilled in the art that many variations of the embodiment can be made within the scope and spirit of the present invention.

1. A computer implemented method of analyzing transaction data relating to electronic commerce, the method comprising:
receiving, in an electronic commerce analysis server, first transaction data indicating transactions made by payment cards of a first payment card type;
identifying, in an electronic commerce transaction identification module of the electronic commerce analysis server, first electronic commerce transactions in the first transaction data;
calculating, in an electronic commerce metric calculation module of the electronic commerce analysis server, an electronic commerce metric for the first payment card type using the first electronic commerce transactions;
receiving, in the electronic commerce analysis server, first electronic billing information for the payment cards of the first payment card type;
calculating, in an electronic billing metric calculation module of the electronic commerce analysis server, an electronic billing metric for the first payment card type using the first electronic billing information; and
determining, in a composite metric calculation module of the electronic commerce analysis server, a composite metric for the first payment card type from the electronic commerce metric for the first payment card type and the electronic billing metric for the first payment card type.

2. A method according to claim 1, further comprising analyzing the composite metric for the first payment card type in an analysis module of the electronic commerce analysis server.

3. A method according to claim 2, wherein analyzing the composite metric for the first payment card type comprises comparing the composite metric for the first payment card type with composite metric value.

4. A method according to claim 3, wherein the composite metric value is an average composite metric for a plurality of payment card types.

5. A method according to claim 3, wherein the composite metric value is a maximum composite metric value for a plurality of payment card types.

6. A method according to claim 2, wherein analyzing the composite metric value comprises estimating a decrease in cost and/or an increase in revenue for the first payment card type if the composite metric for the first payment card type increased to the composite metric value.

7. A method according to claim 1, wherein calculating the electronic commerce metric for the first payment card type using the first electronic commerce transactions comprises calculating a proportion of the transactions made by the first payment card type that are electronic commerce transactions.

8. A method according to claim 1, wherein calculating the electronic billing metric for the first payment card type using the first electronic billing information comprises calculating a proportion of first payment card accounts registered for electronic billing.

9. A method according to claim 1, wherein determining the composite metric for the first payment card type from the electronic commerce metric for the first payment card type and the electronic billing metric for the first payment card type comprises calculating a weighted sum of the electronic commerce metric for the first payment card type and the electronic billing metric for the first payment card type.

10. A method according to claim 1, further comprising:
receiving, in the electronic commerce analysis server, second transaction data indicating transactions made by payment cards of a second payment card type;
identifying second electronic commerce transactions in the second transaction data;
calculating an electronic commerce metric for the second payment card type using the second electronic commerce transactions;
receiving second electronic billing information for the payment cards of the second payment card type;
calculating an electronic billing metric for the second payment card type from the electronic commerce metric for the second payment card type and the electronic billing metric for the second payment card type; and
determining a composite metric for the second payment card type from the electronic commerce metric for the second payment card type and the electronic billing metric for the second payment card type.

11. A method according to claim 10, further comprising analyzing the composite metric for the first payment card type and the composite metric for the second payment card type.

12. A method according to claim 11, wherein analyzing the composite metric for the first payment card type and the composite metric for the second payment card type comprises comparing the composite metric for the first payment card type and the composite metric for the second payment card type.

13. A non-transitory computer readable medium having stored thereon program instructions for causing at least one processor to perform a method comprising:
receiving first transaction data indicating transactions made by payment cards of a first payment card type;
identifying first electronic commerce transactions in the first transaction data;
calculating an electronic commerce metric for the first payment card type using the first electronic commerce transactions;
receiving first electronic billing information for the payment cards of the first payment card type;
calculating an electronic billing metric for the first payment card type using the first electronic billing information; and
determining a composite metric for the first payment card type from the electronic commerce metric for the first payment card type and the electronic billing metric for the first payment card type.

14. An apparatus for analyzing transaction data relating to electronic commerce, the apparatus comprising:
a computer processor and a data storage device, the data storage device having an electronic commerce transaction identification module; an electronic commerce metric calculation module; an electronic billing metric calculation module; and a composite metric calculation module comprising non-transitory instructions operative by the processor to:
receive first transaction data indicating transactions made by payment cards of a first payment card type;
identify first electronic commerce transactions in the first transaction data;
calculate an electronic commerce metric for the first payment card type using the first electronic commerce transactions;
receive first electronic billing information for the payment cards of the first payment card type;
calculate an electronic billing metric for the first payment card type using the first electronic billing information; and
determine a composite metric for the first payment card type from the electronic commerce metric for the first payment card type and the electronic billing metric for the first payment card type.

15. An apparatus according to claim 14, wherein the data storage device further comprises an analysis module comprising non-transitory instructions operative by the processor to: analyze the composite metric for the first payment card type.

16. An apparatus according to claim 15, wherein the analysis module further comprises non-transitory instructions operative by the processor to: compare the composite metric for the first payment card type with composite metric value.

17. An apparatus according to claim 16, wherein the composite metric value is an average composite metric for a plurality of payment card types.

18. An apparatus according to claim 16, wherein the composite metric value is a maximum composite metric value for a plurality of payment card types.

19. An apparatus according to claim 15, wherein the analysis module further comprises non-transitory instructions operative by the processor to: estimate a decrease in cost and/or an increase in revenue for the first payment card type if the composite metric for the first payment card type increased to the composite metric value.

20. An apparatus according to claim 14, wherein the electronic commerce metric calculation module further comprises non-transitory instructions operative by the processor to: calculate a proportion of the transactions made by the first payment card type that are electronic commerce transactions.

21. An apparatus according to claim 14, wherein the electronic billing metric calculation module further comprises non-transitory instructions operative by the processor to: calculating a proportion of first payment card accounts registered for electronic billing.

22. An apparatus according to claim 14, wherein the composite metric calculation module further comprises non-transitory instructions operative by the processor to: calculate a weighted sum of the electronic commerce metric for the first payment card type and the electronic billing metric for the first payment card type.
